(19) United States
(12) Patent Application Publication
(10) Pub. No.: US 2008/0001326 A1
(43) Pub. Date: Jan. 3, 2008

(54) PREGNANCY SCULPTURE

(76) Inventors: Kori Gassaway, Chicago, IL (US); Christine Kurban, Chicago, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/770,043

(22) Filed: Jun. 28, 2007

Related U.S. Application Data
(60) Provisional application No. 60/816,991, filed on Jun. 28, 2006.

(51) Int. Cl. B29C 33/40

(52) U.S. Cl. 264/222; 425/175

(57) ABSTRACT

The invention includes a method and kit for creating a reverse impression of a pregnant woman's torso. The kit can include lotion and/or oil, fabric, sculpting powder, gesso, a paint brush and design materials. The method can include treating a woman's torso with lotion and/or oil, preparing the sculpting mixture by combining the plaster powder with water, dipping the fabric in the sculpting mixture, and molding the plaster infused fabric to the woman's torso and garment(s), if present. The plaster sculpture can then be treated with gesso to preserve and design materials to decorate the belly sculpture.

### CROSS REFERENCE TO RELATED APPLICATIONS

This application claims the benefit and priority of U.S. Provisional Patent Application No. 60/816,991, filed Jun. 28, 2006.

### FIELD OF THE INVENTION

The invention relates to a new method and kit for creating a pregnancy sculpture. In particular, the invention relates to a pregnancy sculpture kit used to make a reverse impression of a pregnant woman's torso.

### BACKGROUND OF THE INVENTION

Belly casts are known in the art and are also commonly referred to as “belly molds” and “belly masks.” A belly cast is a mold made of multiple casting strips, typically used for casting a broken limb or body part. The casting strips are dipped in water one by one, and then shaped around a mother's torso during pregnancy.

The invention is a new method and kit for creating a pregnancy sculpture. Casting strips are not used, but rather one piece of fabric. Pregnancy sculptures may be decorated, painted, or saved for future reminiscence by the mother, father, and family. The pregnancy sculpture most often serves as a keepsake reminder of the pregnancy and motherhood experience. Belly sculptures may be created at home or in a spa, and are typically performed between the 28^{th} and 40^{th} week of pregnancy.

### SUMMARY OF THE INVENTION

The invention includes a new method and kit for creating a reverse impression of a pregnant woman's torso. The kit can include lotion and/or oil, fabric, sculpting powder, gesso, a paint brush and/or art materials to design the finished belly sculpture. The method can include treating a woman's torso with lotion and/or oil, preparing the sculpting mixture by combining the plaster powder with water, dipping the fabric in the sculpting mixture, and molding the plaster infused fabric to the woman's torso and garment(s), if present. The plaster sculpture can then be treated with gesso to preserve the sculpture and/or art materials for design purposes.

### DETAILED DESCRIPTION

The kit for creating a pregnancy sculpture, or belly sculpture, of a pregnant woman's torso includes a lotion and/or oil, fabric, and plaster powder. The kit may also include decorative elements, such as gesso, paint, ribbon or other materials that can be added to the plaster mix or applied after hardening, and may include an applicator such as a brush. Various fabrics can include but are not limited to wool, wool blends, flannel and suede fabric. A suitable plaster powder is USG No. 1 Casting Plaster Powder sold through the U.S. Gypsum Company. Any other suitable plaster powder can be used. The oil or lotion is an aromatherapy blend of various essential oils that may include, but are not limited to lavender, neroli, jojoba oil, grapeseed oil, calendula, vitamin e, and sweet almond oil. The oil and/or lotion is applied to a woman's skin and possibly to garments, such as a bra. The application of the oil and/or lotion helps to create a spa experience for the woman and facilitates the removal of the plaster sculpture once it has hardened.

The method of applying the sculpture is as follows. The lotion and/or oil is applied over the entire torso. If other portions of the mother's body are intended to be sculpted, i.e. the arms or legs, those portions should also receive lotion and/or oil. The plaster powder can be mixed with warm water until the consistency is similar to a watery pancake batter. The single-piece of fabric is then dipped and soaked in the plaster mixture until the mixture is infused in the fabric. Excess plaster mixture may be wrung out of the fabric, and then the fabric can be applied to the woman's torso. The preferred plaster mixture advantageously resists clumping. Moreover, the preferred fabric advantageously absorbs water from the plaster mixture, thereby permitting exceptional curing times. The single-piece of fabric is then applied to a seated, reclined or standing mother's torso and allowed time to harden while on the woman's body. As the fabric is formed to the woman's belly and or other body parts, the edges of the fabric are folded under to create a finished end product.

The plaster-bearing fabric will typically begin to dry and set immediately. It should remain on the torso for about 15-30 minutes. A sponge may be used to wick excess liquid from the belly sculpture or to tap down the fabric where necessary. After the plaster is cured (approximately 15-30 minutes), the pregnancy sculpture may be completely removed and potentially packaged for transportation home. Gesso or other types of finishing design materials may be applied 12-24 hours after curing is complete.

Those of ordinary skill will recognize that the foregoing embodiments may be modified and altered without departing from the spirit and scope of the invention. The described embodiments are to be considered as illustrative and not restrictive.

That which is claimed is:

1. A kit for creating a sculpture of a pregnant woman's torso, the kit comprising:
a lotion or oil consisting of essential oils;
a plaster powder for forming a plaster mixture; and
a piece of fabric for dipping into the plaster mixture and applying to the woman's torso.

2. The kit of claim 1, including an applicator for the lotion or oil.

3. The kit of claim 1, including a fastener for securing the fabric such that application can occur when the woman is upright.

4. The kit of claim 2, including a decorative finishing, for application to the resulting sculpture.

5. The kit of claim 1 wherein only a single piece of fabric is supplied, such fabric to be sufficient to cover the portion of the torso to be sculptured.

6. A method for creating a sculpture of a pregnant woman's torso, the method comprising:
(a) applying a lotion or oil to the woman's torso,
(b) mixing plaster powder with water until a plaster mixture of proper consistency is achieved,
(c) dipping a piece of fabric into the plaster mixture until the mixture is sufficiently infused in the fabric,
(d) removing excess plaster mixture from the fabric,
(e) applying the fabric and plaster to the woman's torso,
(f) allowing the plaster to cure and form a sculpture conforming to the woman's torso,
(g) removing the sculpture from the woman's torso.

7. The method of claim 6, including the step of adding a decorative finish to the sculpture.

8. The method of claim 6, wherein only one piece of fabric is used and the piece covers substantially all of the portion of the torso to be sculptured.

9. The product made in accordance with the method of claim 6.
